(19) United States
(12) Patent Application Publication
(10) Pub. No.: US 2017/0361477 A1
(43) Pub. Date: Dec. 21, 2017

(54) BEARD TRIMMER HAVING ONE OR MORE ROTARY HEADS

(71) Applicant: BaByliss Faco sprl, Wandre (BE)

(72) Inventors: Olivier SMAL, Magnee (BE); Pierre JULEMONT, Soumagne (BE)

(73) Assignee: BaByliss Faco sprl, Wandre (BE)

(21) Appl. No.: 15/535,407

(22) PCT Filed: Dec. 14, 2015
(86) PCT No.: PCT/EP2015/079635

§ 371 Date: Jun. 12, 2017

(30) Foreign Application Priority Data
Dec. 22, 2014 (EP) 14199560.5

(51) Int. Cl. B26B 19/20; B26B 19/14

(52) U.S. Cl. CPC B26B 19/20; B26B 19/14

(57) ABSTRACT

The present invention relates to a beard trimmer having one or more rotary cutting heads having a moving blade and a fixed blade, each head being surrounded by a telescopic comb in the form of a crown, said comb being height adjustable and making it possible to adjust, in use, the distance between said blades and the skin and thus to set the cutting of the beard hairs to the desired length.

### SUBJECT-MATTER OF THE INVENTION

The present invention relates to a beard trimmer comprising at least one, preferably two or three, rotary cutting heads with a vertical axis. The cutting mechanism of these rotary heads is equipped with a moving blade and with a fixed blade. Each cutting head is surrounded by height-adjustable combs in the form of a crown. In use, the combs thus make it possible to adjust the distance between the cutting mechanism and the skin and to adjust the cutting length of the beard.

### STATE OF THE ART

The beard trimmers of the state of the art currently have linear moving and fixed blades, the operation of which is based on a to-and-fro movement of the moving blade relative to the fixed blade. This type of trimmer is generally equipped with a comb making it possible to adjust the cutting length of the beard. Such beard trimmers are for example disclosed in documents U.S. Pat. No. D 698,084, U.S. Pat. No. 6,978,547, U.S. Pat. No. D 486,267, EP 2 766 153 A1, U.S. Pat. No. D 363,809, US 20130042487, U.S. Pat. No. 7,076,878, U.S. Pat. No. D 521,683, etc.

There are of course razors with multiple rotary heads that make it possible to achieve a very close shave, but these cannot be used to trim a beard. Razors do not have combs to adjust the distance between the cutting mechanism and the skin. To the best of our knowledge, in the state of the art, however, there are no beard trimmers with rotary heads.

The trimmers of the state of the art have a straight cutting line at the intersection of the moving teeth and the fixed teeth. They have the drawback of trimming the hairs differently depending on the trimming direction because the beard hairs are most often inclined in one direction, since they almost never grow perpendicular to the skin. Thus, the result of clipping with these trimmers is very different depending on the movement direction over the beard to be trimmed.

Document U.S. Pat. No. 4,888,870 describes a hair trimmer whereof the comb guides the hair toward orifices, where it is cut. Such a device is of course not suitable for trimming a beard, if only due to the large diameter of the comb not allowing the adjustment of a stable distance between the skin of the face and the moving blade.

### AIMS OF THE INVENTION

The present invention aims to provide a trimmer with one or more rotary heads making it possible to trim a beard evenly and uniformly, independently of the movement direction of the trimmer over the beard to be trimmed. It makes it possible to obtain a uniformly trimmed beard having a length between 1 and 10 mm, preferably between 2 and 8 mm.

### SUMMARY OF THE INVENTION

The present invention discloses a beard trimmer comprising one or more rotary cutting heads, said rotary cutting heads comprising a moving blade and a fixed blade, each head being surrounded by a comb in the form of a crown, said comb being height-adjustable and making it possible to adjust, in use, the distance between said blades and the skin, and thus to set the cutting of the beard hairs to the desired length.

The preferred embodiments of the invention comprise at least one, or any appropriate combination, of the following features:
the trimmer comprises one, two or three rotary heads;
the trimmer further comprises a central spacer on at least one of the rotary heads;
the height adjustment of the combs is motorized and can be positioned to within about a millimeter;
the fixed blade comprises star-shaped radial notches to facilitate the penetration of hairs in the rotary head when they come closer to the center of said fixed blade during trimming of the beard;
said trimmer comprises a removable cover;
the crown-shaped comb is made primarily from a metal material;
the crown-shaped comb is completely retractable in the removable cover;
the comb allows the adjustment of a distance between the cutting mechanism and the skin comprised between 0 and 20 mm, preferably between 1 and 15 mm, and particularly preferably between 2 and 12 mm.

### BRIEF DESCRIPTION OF THE FIGURES

FIG. 1 shows a beard trimmer according to the invention comprising three rotary heads. The crown-shaped comb around the rotary heads is shown with three different adjustment heights. These three adjustments for example make it possible to obtain hair lengths of 2, of 6 and 10 mm.

FIG. 2 shows a beard trimmer according to the invention with an alternative where a spacer in the form of a central stop has been added. The spacer is adjusted to the same height as the combs shown in three different positions. The spacer has the same function as the combs, i.e., maintaining the distance between the cutting mechanism and the skin.

FIG. 3 shows a detailed view of a cutting head in its version with a central spacer, and with several adjustment heights of the comb. The figure makes it possible to respectively distinguish the cutting lengths of the beard hairs that these positions make it possible to obtain. The presence of a spacer allows the greatest precision for cutting lengths between 2 and 6 mm.

FIG. 4 shows a view similar to FIG. 3, but in an embodiment with no central spacer.

FIGS. 5a and 5b schematically show two different views of the height-adjustment mechanism of the combs. The translational movement of the combs can be done manually by pressing a slide-type button, or can be motorized (not shown).

FIG. 6 shows a three-dimensional view of the trimmer according to the invention with its removable cover making it possible to facilitate cleaning of the cutting mechanism.

FIG. 7 shows a planar view of part of the cutting mechanism and crown-shaped comb.

FIG. 8 shows an exploded view of the cutting head of the trimmer according to the invention, in particular with a spring making it possible to push the moving blade against the fixed blade.

FIG. 9 shows a detailed view of the mechanism according to which the hairs are cut by the cutting head of the device according to the invention.

FIG. 10 shows the movement of a cutting head in use with two different cutting heights.

FIG. 11 shows an exploded view of an embodiment with three heads of the trimmer according to the invention with all of the component elements.

FIG. 12 shows embodiments of the trimmer according to the invention with one and two rotary cutting heads.

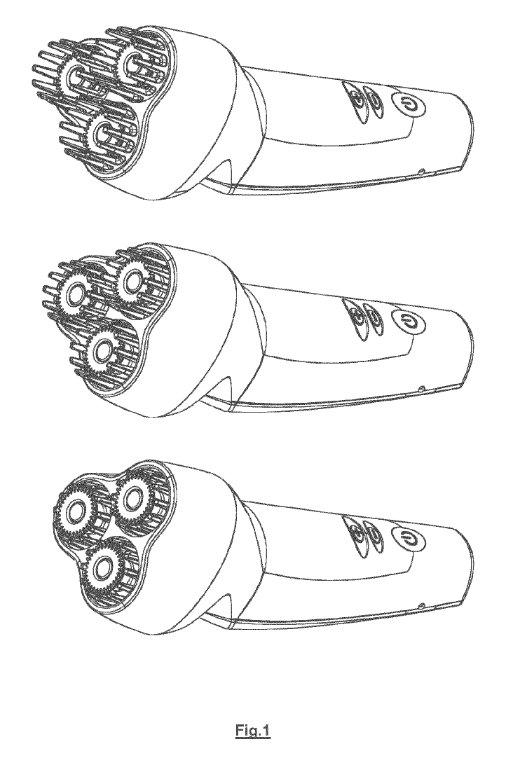

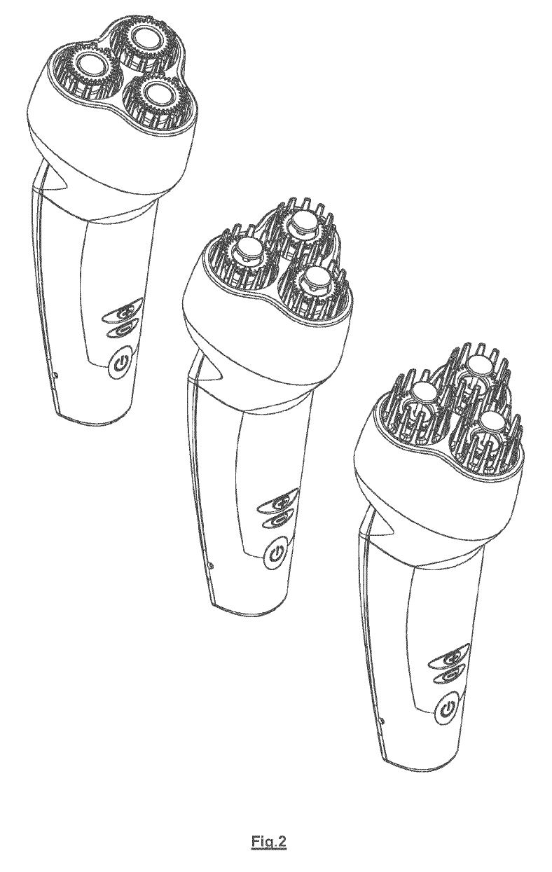

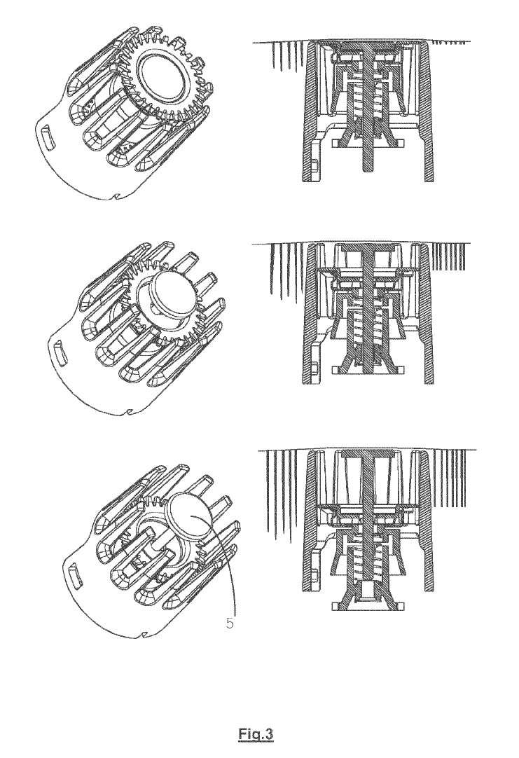

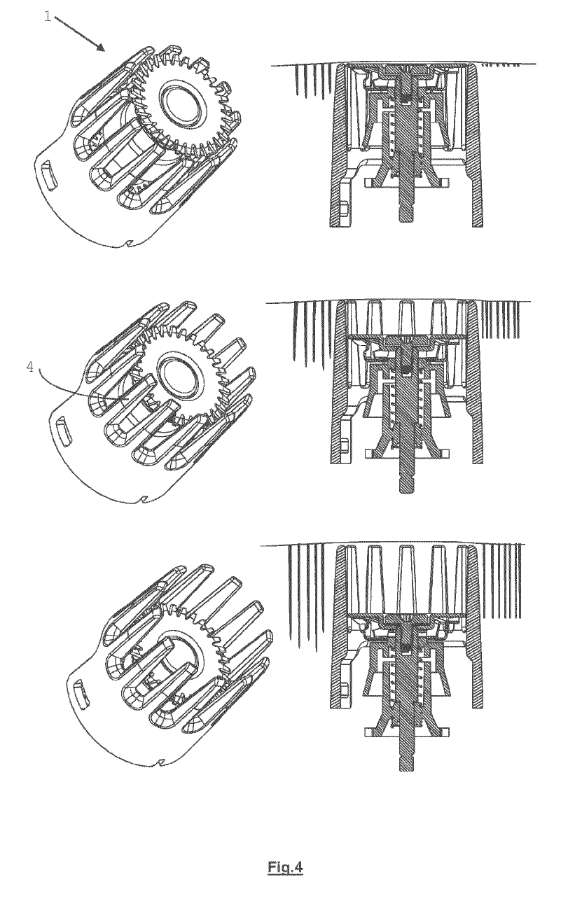

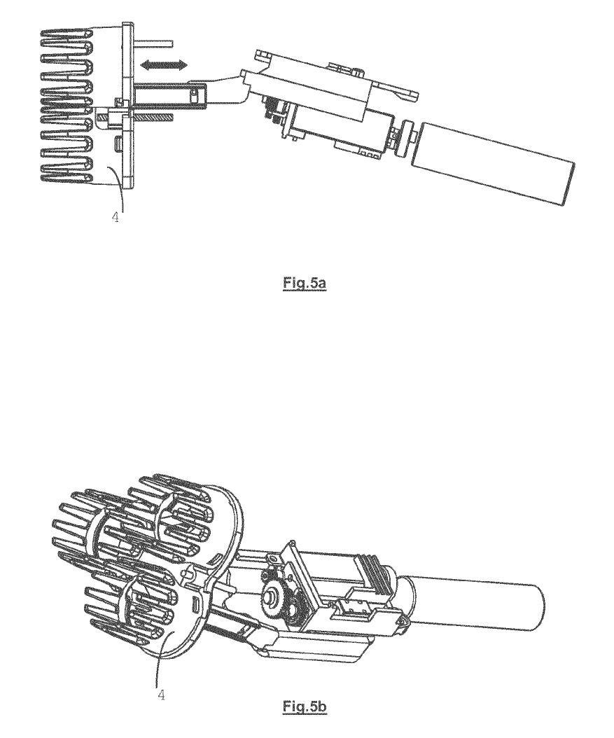

### LIST OF REFERENCE SYMBOLS

1. Circular rotary head with vertical axis
2. Moving blade
3. Fixed blade
4. Crown-shaped comb surrounding the cutting head
5. Central spacer (stop)
6. Removable cover
7. Beard hairs

### DETAILED DESCRIPTION OF THE INVENTION

Unlike the beard trimmers of the state of the art, the trimmer according to the present invention has one or more circular rotary heads 1 with a vertical axis, surrounded by crown-shaped combs 4, the height of which can be adjusted to within a millimeter. This adjustment can be manual or motorized (not shown). This trimmer allows an arcuate movement over the beard, like a razor with rotary heads. This type of movement has the advantage of starting trimming of the hairs on all sides, irrespective of the incline thereof relative to the skin, which results in a uniform trim of the beard.

The movement of the combs 4 stands up the hairs, which ultimately penetrate from the outside toward the inside via the space left free between two teeth in the trimming zone. The particular shape of the teeth of the comb 4, which gradually become thinner toward the tip, allows easy penetration of beard hairs toward the trimming element made up of a fixed blade 3 and a moving blade 2.

The fixed blade 3 comprises radial notches, which also favors the penetration of hairs in the cutting mechanism.

The height of the telescopic combs 4 can be adjusted approximately between 0 and 15 mm, preferably between 0 and 12 mm, and particularly preferably between 0 and 10 mm. The combs are therefore completely retractable in the cover 6 to take up less space when the trimmer is stowed. This is the only interest of the adjustment to 0 mm, since a razor would of course be more suitable for simply shaving the hairs to a length of about 0 mm.

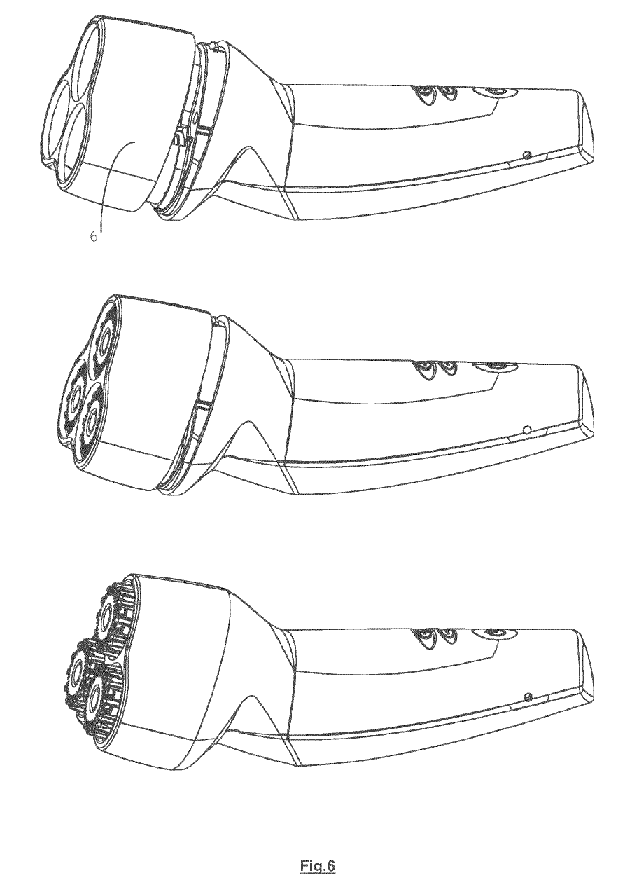

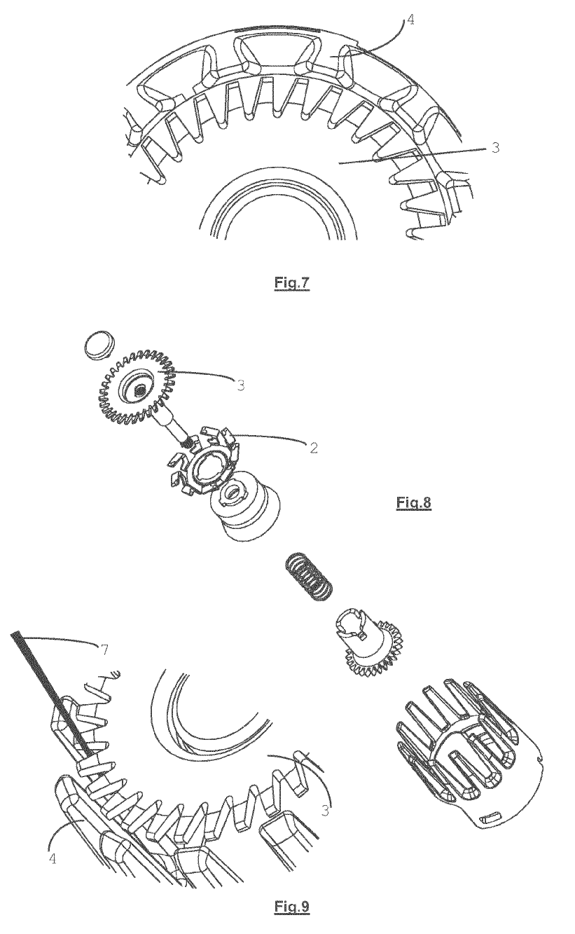

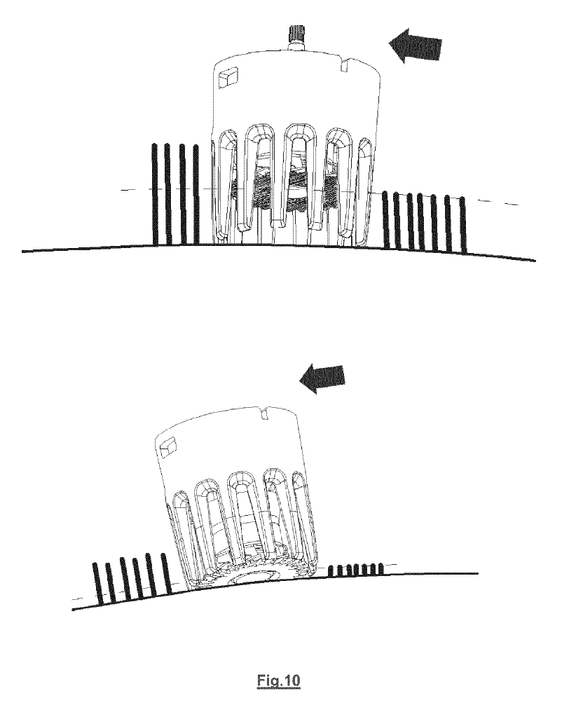

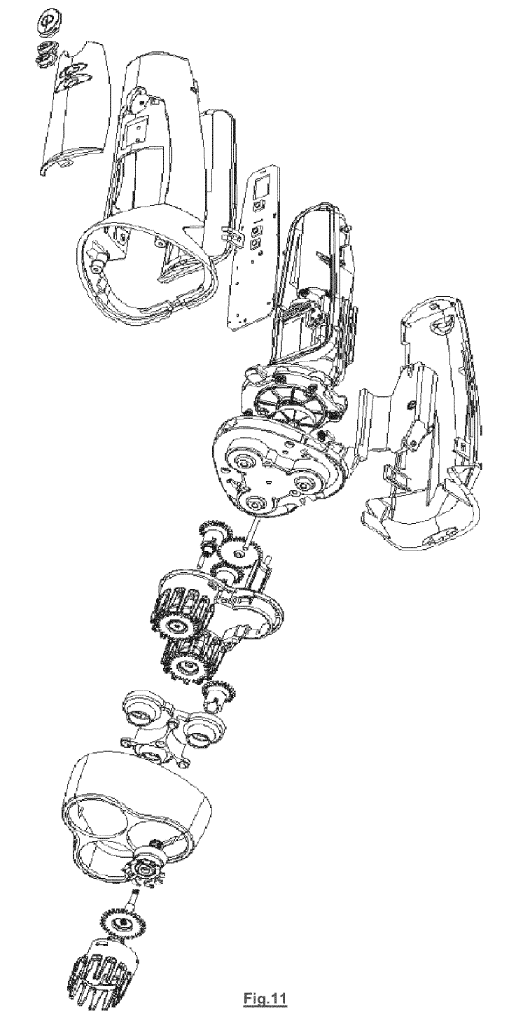

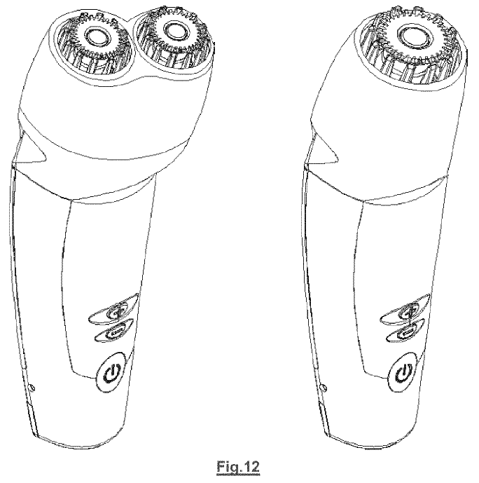

The cover 5 surrounding the rotary head(s) is removable to facilitate cleaning of the cutting mechanism. FIG. 6 shows the removal of the cover 6. This function is important inasmuch as beard trimming, which is often only done once or twice per week, generates significantly more cutting waste than simple shaving.

1-9. (canceled)

10. A beard trimmer comprising one or more rotary cutting heads, said rotary cutting heads comprising a moving blade and a fixed blade, each head being surrounded by a comb in the form of a crown, said comb being height-adjustable and making it possible to adjust, in use, the distance between said blades and the skin, and thus to set the cutting of the beard hairs to the desired length.

11. The beard trimmer according to claim 10, wherein said trimmer comprises one, two or three rotary heads.

12. The beard trimmer according to claim 10, further comprising a central spacer on at least one of the rotary heads.

13. The beard trimmer according to claim 10, wherein a height adjustment of the combs is motorized and can be positioned to within about a millimeter.

14. The beard trimmer according to claim 10, wherein the fixed blade comprises star-shaped radial notches to facilitate the penetration of hairs in the rotary head when they come closer to a center of said fixed blade during trimming of the beard.

15. The beard trimmer according to claim 10, wherein said crown-shaped comb is made primarily from a metal material.

16. A beard trimmer comprising one or more rotary cutting heads and a removable cover, said rotary cutting heads comprising a moving blade and a fixed blade, each head being surrounded by a comb in the form of a crown, wherein said comb allows adjustment of a distance between a cutting mechanism and a user's skin to a value between 0 and 20 mm, preferably between 1 and 15 mm, and particularly preferably between 2 and 12 mm.

17. The beard trimmer according to claim 16, wherein the crown in the form of a comb is completely retractable in the removable cover.
